(19) United States
(12) Patent Application Publication
(10) Pub. No.: US 2026/0132685 A1
(43) Pub. Date: May 14, 2026

(54) CONTINUOUS ROTATION COILED TUBING ORIENTING TOOL WITH PASSIVE HYDRAULIC CONTROL

(71) Applicant: Schlumberger Technology Corporation, Sugar Land, TX (US)

(72) Inventors: Ashley Bernard Johnson, Cambridge (GB); Jeremy Thomas Murphy, Sugar Land, TX (US)

(21) Appl. No.: 19/379,961

(22) Filed: Nov. 5, 2025

Related U.S. Application Data
(60) Provisional application No. 63/718,036, filed on Nov. 8, 2024.

(51) Int. Cl. E21B 7/06; E21B 17/20; E21B 34/06

(52) U.S. Cl. CPC E21B 7/068; E21B 17/20; E21B 34/06

(57) ABSTRACT

An orienting tool includes a first collar configured to rotate with respect to a second collar. A hydraulic pump is deployed in the first collar. A drive shaft of the hydraulic pump is rotationally coupled to the second collar. The hydraulic pump is configured to provide pressurized hydraulic fluid to a metering valve in the first collar that is configured to restrict flow of the pressurized hydraulic fluid and thereby resist rotation of the drive shaft and the second collar relative to the first collar via back pressure to the hydraulic pump.

### CROSS REFERENCE TO RELATED APPLICATIONS

This application claims the benefit of U.S. Provisional Application Ser. No. 63/718,036 entitled Continuous Rotation Orienting Tool for Coiled Tubing Drilling, filed Nov. 8, 2024, which is incorporated herein by reference in its entirety.

### BACKGROUND

Coiled tubing drilling operations are commonly utilized to drill high dogleg and horizontal wellbore sections. In such coiled tubing drilling operations, the drill bit and bottom hole assembly (BHA) are conveyed into the wellbore via a continuous length of jointless coiled metal tubing that is wound on a large diameter reel at the surface. The reel, pumps, and guides are mounted on a mobile surface unit, and an injector is used to drive the tubing into and out of the well. A mud motor or turbine is commonly employed to rotate the drill bit since the coiled tubing will not rotate in the wellbore.

A coiled tubing bottom hole assembly (BHA) commonly includes an orienting tool, one or more optional logging while drilling (LWD) tools, a measurement while drilling (MWD) tool, a motor or turbine, a bent sub, and a drill bit. When drilling a curved section, the orienting tool is turned to a desired toolface angle such that rotation of the drill bit drills the well along a curved path in the direction of the bent sub. When drilling straight ahead, the orienting tool may be rotated slowly back and forth between diametrically opposed toolface angles.

It will be appreciated that the above-described approach for drilling straight ahead generally results in a wellbore having a tortuous profile. While such tortuosity may be reduced or eliminated by continuously rotating the orienting tool (e.g., as disclosed in U.S. Pat. No. 6,047,784), known implementations of electromechanically actuated orienting tools capable of continuous rotation have proven to be unreliable in commercial coiled tubing drilling operations. There is a need in the industry for a robust, continuous rotation orienting tool for coiled tubing drilling operations.

### SUMMARY

Coiled tubing orienting tools capable of continuous rotation are disclosed. The disclosed embodiments may be passively actuated using hydraulic actuation and/or control and may include a first collar configured to rotate with respect to a second collar. A hydraulic pump is deployed in the first collar. A drive shaft of the hydraulic pump is rotationally coupled to the second collar. The hydraulic pump is configured to provide pressurized hydraulic fluid to a metering valve in the first collar that is configured to restrict flow of the pressurized hydraulic fluid and thereby resist rotation of the drive shaft and the second collar relative to the first collar via back pressure to the hydraulic pump.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example coiled tubing drilling operation employing an orienting tool configured for continuous rotation.

FIG. 2 depicts an example embodiment of an orienting tool capable of continuous rotation via passive hydraulic control.

FIG. 3 depicts an example hydraulic circuit configured to provide passive hydraulic control of the orienting tool shown on FIG. 2.

FIG. 4 depicts a flow chart of one example coiled tubing drilling method using the orienting tool disclosed in FIG. 2.

FIG. 5 depicts a flow chart of another example coiled tubing drilling method using the orienting tool disclosed in FIG. 2.

FIGS. 6A, 6B, and 6C (collectively FIG. 6) depict plots of wellbore azimuth, wellbore inclination, and dogleg severity on the vertical axes versus the measured depth of a straight wellbore section on the horizontal axis for simulated coiled tubing drilling operations.

FIGS. 7A and 7B (collectively FIG. 7) depict plots of wellbore diameter on the vertical axis versus the measured depth of a straight wellbore section on the horizontal axis for simulated coiled tubing drilling operations.

### DETAILED DESCRIPTION

Coiled tubing orienting tools capable of continuous rotation and coiled tubing drilling methods employing such orienting tools are disclosed. In one example embodiment, a disclosed orienting tool includes a first collar configured to rotate with respect to a second collar. A hydraulic pump is deployed in the first collar. A drive shaft of the hydraulic pump is rotationally coupled to the second collar. The hydraulic pump is configured to provide pressurized hydraulic fluid to a metering valve in the first collar that is configured to restrict flow of the pressurized hydraulic fluid and thereby resist rotation of the drive shaft and the second collar relative to the first collar via back pressure to the hydraulic pump.

Disclosed embodiments may advantageously provide an orienting tool capable of continuous rotation in a wellbore during a drilling operation. The disclosed orienting tool is hydraulically actuatable and may therefore provide improved reliability and service. Moreover, the disclosed embodiments may advantageously enable straight sections to be drilled with reduced tortuosity in coiled tubing drilling operations.

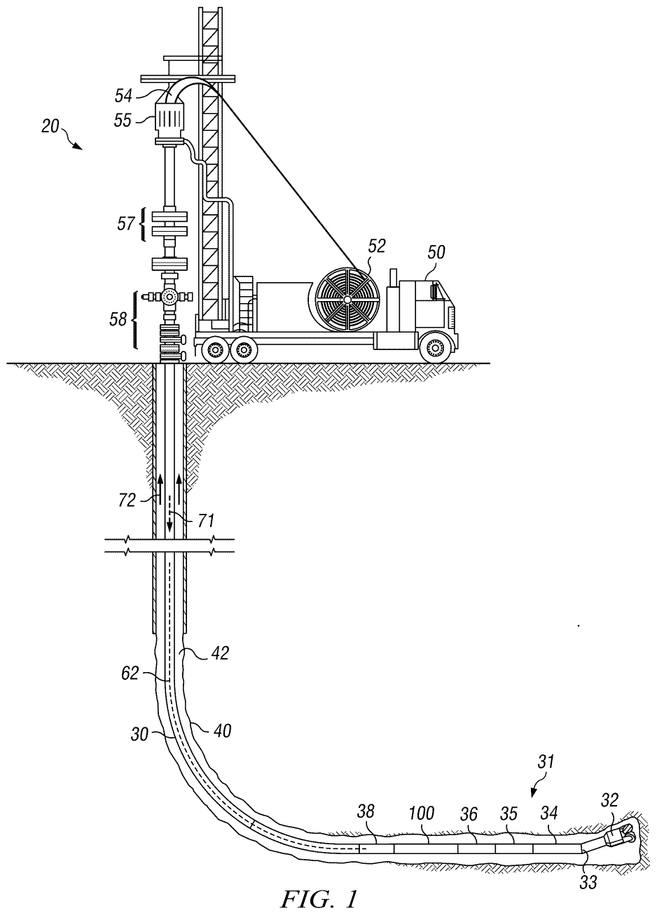

FIG. 1 depicts an example coiled tubing drilling operation 20 including a disclosed orienting tool 100 configured for continuous rotation. In the depicted example embodiment, coiled tubing 30 and other equipment may be delivered into a subterranean wellbore 40 in an oilfield by a truck 50 (or portable platform/rig). The truck 50 accommodates a coiled tubing reel 52 and equipment for threading the coiled tubing 30 through a gooseneck 54 and injector head 55 for advancement of the coiled tubing 30 into the wellbore 40. Other conventional equipment such as a blow-out preventor stack 57 and a master control valve 58 may be employed in directing the coiled tubing 30 into and out of the well 40 or preventing its uncontrollable release to the environment.

The orienting tool 100 may be deployed in a bottom hole assembly (BHA) 31 deployed on (connected to) the downhole end of the coiled tubing 30. The BHA 31 may include, for example, a drill bit 32, a bent housing 33, a mud motor or turbine 34 configured to rotate the drill bit, a measurement while drilling (MWD) tool 35, a logging while drilling (LWD) tool 36, the orienting tool 100, and a drilling head 38 including a disconnect (such as an electrical disconnect). It will be appreciated that the disclosed embodiments are, of course, not limited to any particular BHA configuration and may include other downhole tools than those depicted or fewer downhole tools than those depicted. For example, the use of an LWD tool may be purely optional.

The motor or turbine 34 may include a positive displacement motor or a turbine and may be configured to convert drilling fluid flow (hydraulic force) to rotary motion to rotate the drill bit 32 and drill the wellbore 40. The MWD tool 35 may be configured, for example, to measure wellbore attitude (inclination and azimuth), weight on bit (WOB), torque on bit (TOB), shock and vibration, BHA rotation rate, downhole pressure and temperature, and gamma ray counts, however, the disclosed embodiments are not limited to the use of an MWD tool including any particular sensor deployment.

Data generated by the MWD tool 35, the LWD tool 36, and/or other sensors in the BHA may be transmitted (communicated) uphole while drilling. For example, the data may be transmitted uphole in substantially real time via a wireline link 62. Moreover, control commands may be sent from the surface to the BHA via the wireline link 62. In some embodiments, electric power may also be provided to the BHA via the wireline link 62. For example, the orienting tool 100 may receive electrical power from the wireline link 62 and may communicate electrically via the link 62. As is known to those of ordinary skill in the art, the wireline link 62 may be routed along an interior of or within a wall of the coiled tubing 30.

As noted above, the coiled tubing 30 may be delivered downhole via an injector head 55. In certain embodiments, the injector head 55 may be controlled to slack off or pick up the coiled tubing 30 so as to control the amount of speed of tubing into the wellbore and, correspondingly, the WOB acting on the drill bit 32 or BHA 31. In this way, the rate of penetration (ROP) of the drilling operation may be controlled. Depending on the specifics of the coiled tubing operation, various types of data may be collected downhole, and transmitted to the surface. For example, the data may be used to fully or partially automate downhole operations, to optimize the downhole operations, and/or to provide more accurate predictions regarding components or aspects of the downhole operations as well as to integrate the control of the coiled tubing injection (and ROP), the BHA operation, and the managed pressure or underbalanced drilling.

During a coiled tubing drilling operation, drilling fluid is pumped downhole through the coiled tubing 30 (as depicted at 71) to the motor or turbine 34 to rotate the drill bit 32 and drill the well. As is known to those of ordinary skill in the art, the drilling fluid is also intended to carry cuttings and other debris, comingled or not with formation gases and fluids, to the surface in return flow 72 in the wellbore annulus 42. Coiled tubing drilling may be advantageous in certain drilling applications in that it will not require new stands of drill pipe to be added to a drill string and therefore enables continuous circulation of the drilling fluid and maintenance of smooth bottom hole pressure profiles. Coiled tubing drilling further readily enables underbalanced drilling that may deliver a wellbore having minimal (near zero) skin (or mudcake). Coiled tubing drilling is therefore commonly used to drill lateral or multilateral wellbore sections.

One disadvantage with the use of coiled tubing drilling is that it tends to have a limited lateral reach owing to the build-up of frictional force between the non-rotating coiled tubing and the wellbore wall. When frictional lockup occurs, the coiled tubing no longer advances in the well (such that drilling stops) regardless of the surface parameters (e.g., regardless of the WOB and drilling fluid flow rate). It will be appreciated that the frictional force between the coiled tubing and the wellbore tends to increase significantly with increasing wellbore tortuosity. Reducing wellbore tortuosity may therefore advantageously enable coiled tubing drilling to have increased lateral reach.

During a coiled tubing drilling operation, a curved section of wellbore may be drilled by rotating the orienting tool and bent sub to a predetermined or desired toolface. Continued pumping of the drilling fluid then causes drilling to proceed in a direction that turns towards the toolface of the bent sub. To drill straight ahead, for example, in a lateral, the orienting tool is commonly rotated back and forth between diametrically opposed toolface angles, which tends to cause a tortuous wellbore profile. While wellbore tortuosity may be reduced or substantially eliminated by continuously rotating the orienting tool, known implementations of electromechanically actuated orienting tools capable of continuous rotation have proven to be unreliable in commercial coiled tubing drilling operations. There is a need in the industry for a robust, continuous rotation (continuously rotating) orienting tool for coiled tubing drilling operations. The example embodiments described herein below make use of robust hydraulic actuation and/or hydraulic control and may therefore provide for a continuously rotatable orienting tool having improved reliability and may further advantageously enable laterals and other wellbore sections to be drilled with lower tortuosity.

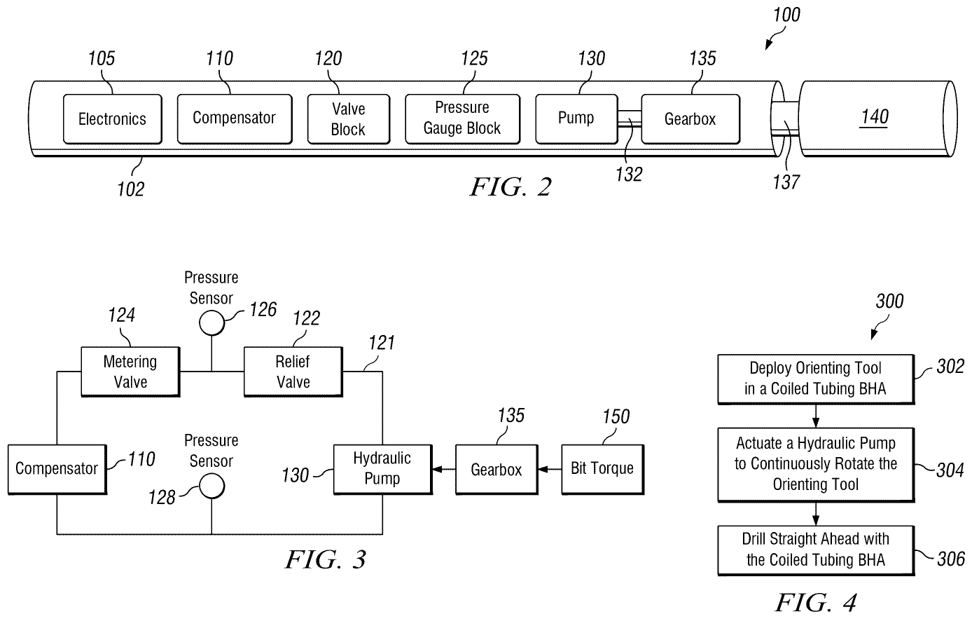

FIG. 2 depicts an example embodiment of an orienting tool 100 capable of continuous rotation via passive hydraulic control. The orienting tool may include a first collar 102 configured to rotate with respect to a second collar 140. In example embodiments (such as depicted) the first collar 102 may be an upper collar and the second collar 140 may be a lower collar, however the disclosed embodiments are expressly not limited in this regard. Orienting tool 100 includes an electrical chassis 105, an oil compensator 110, a hydraulic valve block 120, a pressure gauge block 125, a hydraulic pump 130, and a gear box 135 deployed in the first collar 102. The assembly is configured to passively control continuous rotation (e.g., the rotation rate) of a second collar 140 of the tool orienting 100 on demand.

The gearbox 135 may be mechanically coupled with a shaft 137 that is in turn rotationally coupled with the second collar 140. The orienting tool 100 is configured to make use of back torque (reactive torque) from the drill bit 32 (which is located below the second collar—see FIG. 1) through the second collar 140 to control the rotation of the orienting tool in a direction opposite of the drill bit rotation.

The electrical chassis 105 may be connected with wireline 62 (FIG. 1) and may include an electronic controller in electronic communication with the surface. In example embodiments, the controller may be configured to control a smart metering valve 124 (and therefore control orienting tool functionality) as described in more detail below.

The oil compensator 110 (or pressure compensator) may be configured to automatically modulate hydraulic fluid pressure within the orienting tool 100 (e.g., in the valve block 120, the pressure gauge block 125, and the hydraulic pump 130). Substantially any suitable oil compensator may be utilized. In example embodiments the oil compensator 110 may include an adjustable orifice to modulate fluid flow that is provided to the valve block and hydraulic motor. The disclosed embodiments are not limited to any particular oil compensator configuration.

It will be appreciated that the electrical chassis 105, the oil compensator 110, the valve block 120, the pressure gauge block 125, the hydraulic pump 130, and the gear box 135 are not necessarily located in the relative positions shown in FIG. 2. For example, the oil compensator 110 is not necessarily located adjacent to the electrical chassis 105. In alternative embodiments, the oil compensator 110 may be located in proximity to the hydraulic pump 130 or in proximity to the valve block 120 and pressure gauge block 125. The disclosed embodiments are not limited in these regards.

FIG. 3 depicts an example hydraulic circuit configured to enable continuous rotation of the orienting tool 100 via passive hydraulic control. As depicted, bit torque 150 from the drill bit (as the drill bit engages/drills the formation) provides rotary torque (in the opposite direction as the drill bit rotation) to shaft 137, which in turn rotates the gearbox 135 and drives the hydraulic pump 130 (via shaft 132). The gearbox 135 may be rotationally coupled with the shaft 137 and second collar 140 as described above. It will be appreciated that the gearbox 135 may include substantially any suitable gearbox, for example, including a mechanical or magnetic gearbox that is configured to step down (decrease) the reactive torque and step up (increase) the pump speed (e.g., having a gear ratio in a range from about 1:500 to about 1:5000 or from about 1:1000 to about 1:3000).

The depicted example valve block 120 includes a pressure relief valve 122 and a metering valve 124 (such as a variable orifice valve). The pressure relief valve 122 may be configured to release high pressure fluid in conduit 121 to return conduit 122 when the pressure in conduit 121 exceeds a threshold. The use of a pressure relief valve 122 may be advantageous, for example, to moderate pressure shocks emanating, for example, from dynamic drilling events such as stick slip high frequency torsional oscillations.

The metering valve 124 may be configured to restrict flow in the circuit and thereby control the rotation rate of the shaft 137 and the second collar 140 via back pressure in conduit 121 to the pump 130. In this way, the orienting tool 100 may be configured to have a variable (and controllable) continuous rotation rate. In example embodiments the rotation rate may be controlled over a range from about 0.1 rpm to about 20 rpm (e.g., from about 0.2 to about 10 rpm or from about 0.5 to about 5 rpm).

In example embodiments, the metering valve 124 may be advantageously controlled (e.g., using a tool controller deployed in the electrical chassis 105) via closed loop using feedback from pressure sensor measurements made in pressure gauge block 125. For example, the metering valve 124 may be adjusted to maintain an approximately constant pressure (or a pressure between upper and lower thresholds) at pressure sensor 126 or an approximately constant differential pressure (or a differential pressure between upper and lower thresholds) between pressure sensors 126 and 128. In such example embodiments, the metering valve 124 may be incrementally adjusted in the open direction when the pressure at sensor 126 or the differential pressure across sensors 126 and 128 exceeds an upper threshold and may be incrementally adjusted in a closed direction when the pressure at sensor 126 or the differential pressure across the sensors 126 and 128 is less than a lower threshold.

In other example embodiments, the rotation rate may be controlled via closed loop control using toolface and/or rotation rate measurements made by the MWD tool 35 or by sensors in the orienting tool 100. For example, a tool controller (e.g., deployed in the electrical chassis 105) may receive such rotation rate measurements and use the received measurements in a feedback with the electrical motor or hydraulic pump 120 such that the controller may close (e.g., incrementally close) the metering valve 124 when the rotation rate measurements indicate that the rotation rate is greater than a desired rate or upper rate threshold and open (e.g., incrementally open) the metering valve 124 when the rotation rate measurements indicate that the rotation rate is less than a desired rate or lower rate threshold.

It will be appreciated that, while not depicted, the orienting tool 100 may further include a brake configured to secure or lock the orienting tool at a particular rotational orientation. For example, the brake may be engaged while steering and disengaged when drilling straight ahead continuously rotating the orienting tool. The brake may be deployed, for example, in the gearbox 135 or along shaft 137. In some embodiments, the brake may be hydraulically actuated, for example, by closing the metering valve 124 when the orienting tool is positioned at the desired rotational orientation. The brake may be released prior to initiating the continuous rotation of the second collar 140.

FIG. 4 depicts a flow chart of one example coiled tubing drilling method 300 using the orienting tool disclosed in FIG. 2. A hydraulically actuated orienting tool (e.g., orienting tool 100) is deployed in a coiled tubing BHA which is in turn deployed in a wellbore at 302. The coiled tubing BHA may then be used to drill straight ahead at 306 such that the drilling actuates a hydraulic pump via reactive torque, thereby continuously rotating the orienting tool (rotating the second collar with respect to the first collar).

The method 300 may further include incrementally opening a metering valve to increase a rotation rate of the second collar with respect to the first collar while drilling at 306 and/or incrementally closing the metering valve to decrease the rotation rate of the second collar with respect to the first collar while drilling at 306. For example, the incrementally opening and incrementally closing of the metering valve may be in response to a rotation rate measurement of the second collar. In other example embodiments the incrementally opening and incrementally closing may be in response to pressure measurements or differential pressure measurements made on the upstream and/or downstream sides of the hydraulic pump.

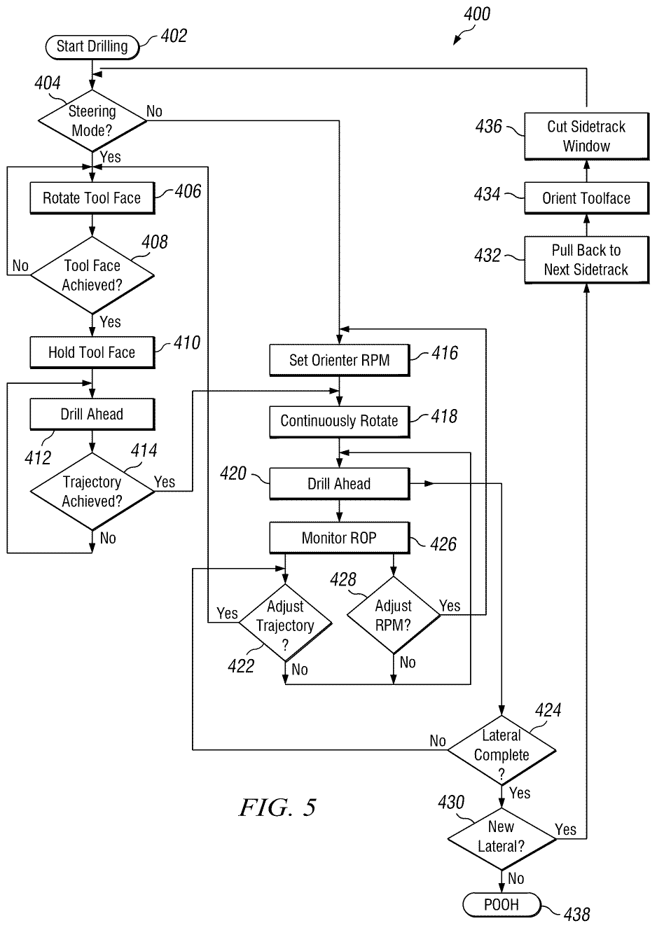

FIG. 5 depicts a flow chart of another example coiled tubing drilling method 400 using the orienting tool disclosed in FIG. 2. In the depicted example, drilling starts at 402 (e.g., after deployment of the coiled tubing string at the desired depth in the wellbore). When steering is employed at 404, the orienting tool may be rotated to point the bent sub to a predetermined toolface at 406. The toolface angle may be verified at 408, for example, using MWD measurements and secured or held at 410 using a brake or other suitable mechanism in the orienting tool. Drilling the curved section may then proceed at 412 until the desired trajectory has been achieved at 414.

When steering is not employed at 404 (such that the wellbore is intended to be drilled straight along the current trajectory), the orienting tool may be continuously rotated at a predetermined rotation rate at 416, 418 (e.g., by releasing the brake and actuating a hydraulic pump as described above). Drilling the straight section may then proceed at 420 until a trajectory adjustment is required at 422 or the lateral or straight wellbore section is completed at 424. The method may return to 406 when trajectory adjustment is required at 422. The rate of penetration may be optionally monitored at 426 and the continuous rotation rate of the orienting tool adjusted at 428 and 416, for example, to provide an optimum ROP/RPM ratio and to minimize wellbore tortuosity.

In example embodiments in which the coiled tubing drilling operation 400 is used to drill laterals, the method may pull back to the next side track depth at 432 when the drilling plan includes an additional lateral at 430. Upon arriving at the side track depth, the orienting tool may be rotated to a predetermined side track toolface at 434 and the sidetrack window may be cut at 436 before returning to 402 to initiate lateral drilling. In the event that no additional lateral sections are required, the coiled tubing string may be pulled out of the hole at 438.

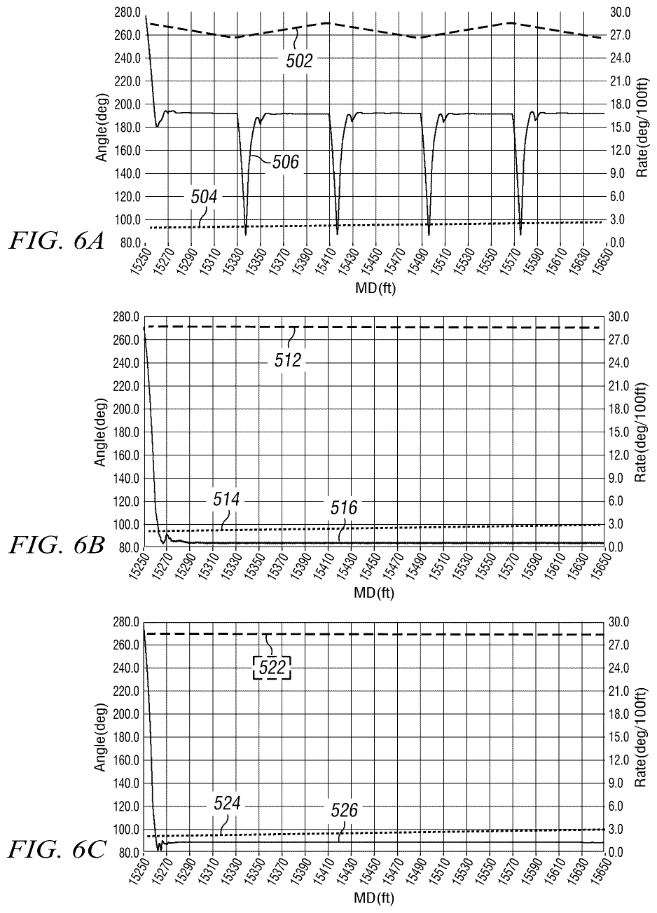

FIGS. 6A, 6B, and 6C (collectively FIG. 6) depict plots of wellbore azimuth 502, 512, 522, wellbore inclination 504, 514, 524, and dogleg severity 506, 516, 526 on the vertical axes versus measured depth of a straight wellbore section on the horizontal axis for a simulated coiled tubing drilling operation. In the simulation shown on FIG. 6A, the orienting tool was rotated back and forth between diametrically opposed toolface angles at a measured depth interval of about 80 ft (about 25 m). Note that the wellbore azimuth 502 oscillated back and forth between about 258 degrees and 272 degrees and that the dogleg severity was about 17 degrees per 100 ft (except when the orienting tool was rotated). In the simulation shown on FIG. 6B, the orienting tool was rotated continuously at a rotation rate of 0.5 rpm. Note that the azimuth remained steady at about 272 degrees and the dogleg severity was about 1 degree per 100 ft. In the simulation shown on FIG. 6C, drilling was simulated with a straight BHA (no bent sub). Note that the azimuth remained steady at about 272 degrees and the dogleg severity was about 1 degree per 100 ft. Note also that the continuous rotation of the orienting tool at a rotation rate of 0.5 rpm advantageously produced an essentially identical wellbore to drilling with a straight BHA.

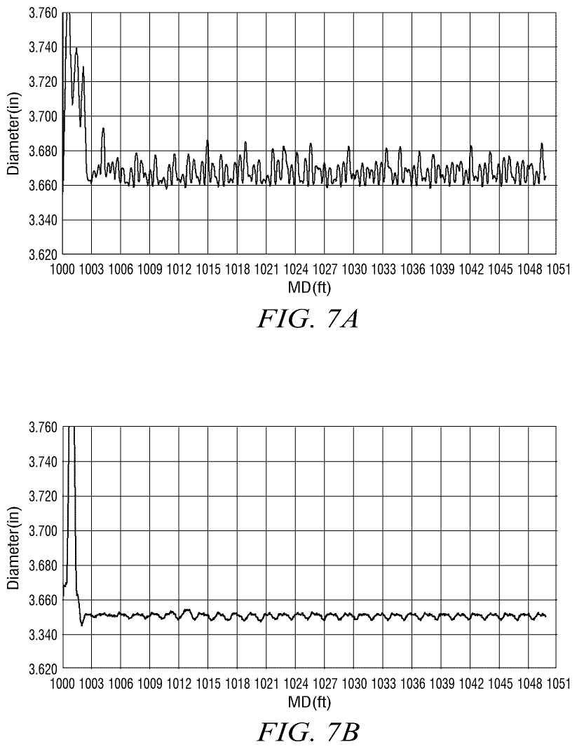

FIGS. 7A and 7B depict plots of wellbore diameter on the vertical axis versus measured depth of a straight wellbore section on the horizontal axis for simulated coiled tubing drilling operations. In FIG. 7A the orienting tool rotated continuously at 0.5 rpm and the ROP was 20 ft/hr. In FIG. 7B the orienting tool rotated continuously at 0.5 rpm and the ROP was 50 ft/hr. Note that the wellbore diameter was greater at the lower rate of penetration (7A) indicating a lower wellbore tortuosity. These simulations indicate that the wellbore tortuosity may depend on the rotation rate of the orienting tool and the rate of penetration of drilling and that it may be advantageous to make use of higher orienting tool rotation rates when the rate of penetration is higher. As indicated above in FIG. 5, the rotation rate of the orienting tool may be adjusted at 428 in response to the measured rate of penetration at 426.

While not disclosed in FIG. 2, it will be appreciated that the disclosed orienting tool embodiments may further include one or more electronic controllers configured, for example, to execute closed loop control of the rotation rate as well to control smart (controllable) components in the orienting tool. A suitable controller may include, for example, a programmable processor, such as a digital signal processor or other microprocessor or microcontroller and processor-readable or computer-readable program code embodying logic. A suitable controller may also optionally include other controllable components, such as other sensors, data storage devices, power supplies, timers, and the like. A suitable controller may also optionally communicate with the surface as well as other instruments in the BHA, such as, for example, the MWD tool. A suitable controller may further optionally include volatile or non-volatile memory or a data storage device.

Although a continuous rotation coiled tubing orienting tool with passive hydraulic control has been described in detail, it should be understood that various changes, substitutions and alternations can be made herein without departing from the spirit and scope of the disclosure as defined by the appended claims.

We claim:

1. An orienting tool configured for use in a coiled tubing bottom hole assembly, the orienting tool comprising:
a first collar configured to rotate with respect to a second collar;
a hydraulic pump deployed in the first collar, a drive shaft of the hydraulic pump rotationally coupled to the second collar, the hydraulic pump configured to provide pressurized hydraulic fluid to a metering valve in the first collar; and
the metering valve configured to restrict flow of the pressurized hydraulic fluid and thereby resist rotation of the drive shaft and the second collar relative to the first collar via back pressure to the hydraulic pump.

2. The orienting tool of claim 1, wherein the drive shaft is configured to be driven by reactive torque in the second collar from a drill bit engaging a subterranean formation during a coiled tubing drilling operation.

3. The orienting tool of claim 1, wherein the drive shaft is rotationally coupled with the second collar via a gearbox that provides a stepped down rotary torque to the drive shaft.

4. The orienting tool of claim 1, wherein the hydraulic circuit comprises a first pressure sensor deployed upstream of the metering valve in fluid communication with an output pressure of the hydraulic pump.

5. The orienting tool of claim 4, further comprising an electronic controller in electronic communication with the metering valve, the electronic controller configured to:
incrementally open the metering valve to increase a rotation rate of the second collar with respect to the first collar when a fluid pressure at the first pressure sensor exceeds a first upper threshold; and
incrementally close the metering valve to decrease a rotation rate of the second collar with respect to the first collar when a fluid pressure at the first pressure sensor is less than a second lower threshold.

6. The orienting tool of claim 4, wherein the hydraulic circuit comprises a second pressure sensor deployed downstream of the metering valve in fluid communication with an input pressure to the hydraulic pump.

7. The orienting tool of claim 6, further comprising an electronic controller in electronic communication with the metering valve, the electronic controller configured to:
incrementally open the metering valve to increase a rotation rate of the second collar with respect to the first collar when a differential pressure between the first pressure sensor and the second pressure sensor exceeds a first upper threshold; and
incrementally close the metering valve to decrease a rotation rate of the second collar with respect to the first collar when a differential pressure between the first pressure sensor and the second pressure sensor is less than a second lower threshold.

8. The orienting tool of claim 1, further comprising an electronic controller in electronic communication with the metering valve, the electronic controller configured to:
receive a rotation rate measurement of the second collar;
incrementally close the metering valve to decrease a rotation rate of the second collar with respect to the first collar when the rotation rate measurement exceeds a first upper threshold; and
incrementally open the metering valve to increase a rotation rate of the second collar with respect to the first collar when the rotation rate measurement is less than a second lower threshold.

9. The orienting tool of claim 1, further comprising a brake configured to prevent rotation of the second collar with respect to the first collar.

10. The orienting tool of claim 1, further comprising a pressure relief valve deployed upstream of the metering valve in fluid communication with an output pressure of the hydraulic pump.

11. A method for coiled tubing drilling comprising:
deploying a coiled tubing bottom hole assembly in a wellbore, the bottom hole assembly including an orienting tool comprising a first collar configured to rotate with respect to a second collar, a hydraulic pump deployed in the first collar, a drive shaft of the hydraulic pump rotationally coupled to the second collar, the hydraulic pump configured to provide pressurized hydraulic fluid to a metering valve in the first collar, and the metering valve configured to restrict flow of the pressurized hydraulic fluid and thereby resist rotation of the drive shaft and the second collar relative to the first collar via back pressure to the hydraulic pump; and
using the coiled tubing bottom hole assembly to drill the wellbore, the drive shaft driven by reactive torque in the second collar from the drilling to actuate the hydraulic pump such that the second collar rotates with respect to the first collar.

12. The method of claim 11, further comprising:
incrementally opening the metering valve to increase a rotation rate of the second collar with respect to the first collar while drilling; or
incrementally closing the metering valve to decrease a rotation rate of the second collar with respect to the first collar while drilling.

13. The method of claim 11, further comprising
measuring a pressure of the pressurized hydraulic fluid;
incrementally opening the metering valve to increase a rotation rate of the second collar with respect to the first collar when the measured pressure exceeds a first upper threshold; and
incrementally closing the metering valve to decrease a rotation rate of the second collar with respect to the first collar when the measured pressure is less than a second lower threshold.

14. The method of claim 11, further comprising
receiving a rotation rate measurement of the second collar;
incrementally closing the metering valve to decrease a rotation rate of the second collar with respect to the first collar when the rotation rate measurement exceeds a first upper threshold; and
incrementally opening the metering valve to increase a rotation rate of the second collar with respect to the first collar when the rotation rate measurement is less than a second lower threshold.

15. The method of claim 11, wherein:
the orienting tool further comprises a brake configured to prevent rotation of the second collar with respect to the first collar, and
the method further comprises releasing the break prior to actuating the hydraulic pump.

16. An orienting tool configured for use in a coiled tubing bottom hole assembly, the orienting tool comprising:
a first collar configured to rotate with respect to a second collar;
a hydraulic pump deployed in the first collar, a drive shaft of the hydraulic pump rotationally coupled to the second collar, the hydraulic pump configured to provide pressurized hydraulic fluid to a metering valve in the first collar;
the metering valve configured to restrict flow of the pressurized hydraulic fluid and thereby resist rotation of the drive shaft and the second collar relative to the first collar via back pressure to the hydraulic pump; and
an electronic controller configured to:
incrementally open the metering valve to increase a rotation rate of the second collar with respect to the first collar; and
incrementally close the metering valve to decrease a rotation rate of the second collar with respect to the first collar.

17. The orienting tool of claim 16, further comprising a first pressure sensor deployed upstream of the metering valve in fluid communication with an output pressure of the hydraulic pump, wherein the controller is configured to incrementally open the metering valve when a fluid pressure at the first pressure sensor exceeds a first upper threshold and incrementally close the metering when a fluid pressure at the first pressure sensor is less than a second lower threshold.

18. The orienting tool of claim 16, further comprising first and second pressure sensors deployed upstream and downstream of the metering valve, wherein the controller is configured to incrementally open the metering valve when a differential pressure between the first pressure sensor and the second pressure sensor exceeds a first upper threshold and incrementally close the metering valve when a differential pressure between the first pressure sensor and the second pressure sensor is less than a second lower threshold.

19. The orienting tool of claim 16, wherein the controller is configured to receive a rotation rate measurement of the second collar, incrementally close the metering valve when the rotation rate measurement exceeds a first upper threshold and incrementally open the metering valve when the rotation rate measurement is less than a second lower threshold.

20. The orienting tool of claim 16, further comprising:
a gearbox coupled between the drive shaft and the second collar that provides a stepped down rotary torque to the drive shaft;
a brake configured to prevent rotation of the second collar with respect to the first collar; and
a pressure relief valve deployed upstream of the metering valve in fluid communication with an output pressure of the hydraulic pump.
